(19) United States
(12) Patent Application Publication
(10) Pub. No.: US 2014/0149911 A1
(43) Pub. Date: May 29, 2014

(54) ELECTRONIC MUSICAL INSTRUMENT AND APPLICATION FOR SAME

(71) Applicant: Chi Kin Lam, Sydney (AU)

(72) Inventor: Chi Kin Lam, Sydney (AU)

(73) Assignee: Chi Kin Lam, Sydney (AU)

(21) Appl. No.: 14/092,886

(22) Filed: Nov. 27, 2013

(30) Foreign Application Priority Data
Nov. 29, 2012 (AU) 2012905204

(51) Int. Cl. G06F 3/0484

(52) U.S. Cl. CPC G06F 3/0484
USPC 715/771

(57) ABSTRACT

Disclosed is a musical instrument simulator executable on a portable computing device to cause the portable computing device to: display a first interface defining a plurality of keys and at least one key modifier; and generate a target sound in response to a user manipulation of one or more of the plurality of keys and the at least one key modifier.

### FOREIGN PRIORITY

This application claims priority under 35 USC 119(a) from Australian provisional application no. 2012905204, filed on 29 Nov. 2012.

### TECHNICAL FIELD

The present invention relates to electronic musical instruments and software applications for realizing the same. The present invention has particular but not exclusive application with portable electronic devices capable of simulating a musical instrument.

### BACKGROUND

Musical instruments are an item people often desire to bring with them as they travel. Many musical instruments are, however, fragile, heavy, and/or bulky, making them inconvenient to travel with.

The advent of portable electronic devices such as smart phones and tablets has ameliorated this difficulty somewhat by allowing virtual musical instruments to be created on these portable electronic devices in the form of software. The virtual musical instruments created in this manner are typically played by interacting with a touchscreen interface of the portable electronic device.

Virtual musical instruments created in this manner, however, are constraint by the physical sizes of the touchscreen interfaces. In particular, the touchscreens of such portable electronic devices are typically small, and hence present a difficulty in how to simulate a sufficient and useful range of notes.

One conventional solution has been to compact as many virtual keys onto the touchscreen interface as possible. Compacting virtual keys onto a touchscreen, however, increases the difficulty of playing the virtual instrument, and results often in the playing of an unintended musical note. Further, there is a practical upper limit to how many virtual keys may be compacted onto a touchscreen. This upper limit is typically well short of even a limited range of keys to allow for the playing of a moderately complex song.

Another conventional solution has been to provide a limited range of playable keys. Providing a limited range of playable keys, however, limits the usability of the virtual musical instrument, and the music producible thereby. This relegates the virtual musical instrument to the realm of toys, rather than that of proper musical instruments.

The “Ocarina” application (https://itunes.apple.com/au/app/ocarina/id293053479?mt=8) produced by Smule (hereinafter referred to as “Ocarina”) is an example of a conventional virtual musical instrument. Ocarina simulates an actual ocarina instrument on a smartphone by displaying virtual keys on a touchscreen of the smartphone. Ocarina displays four virtual keys on the smartphone, limiting the number of playable musical notes to 16.

The invention of the present disclosure seeks to overcome, or at least ameliorate, the above and other disadvantages.

### SUMMARY

In one aspect, the present invention provides a musical instrument simulator executable on a portable computing device and configured to cause the portable computing device to display a first interface defining a plurality of keys and at least one key modifier; and generate a target sound in response to a user manipulation of one or more of the plurality of keys and the at least one key modifier.

In one embodiment of the musical instrument simulator, each of the plurality of keys is mapped to a predetermined sound, and the musical instrument simulator causes the portable computing device to generate the target sound from the predetermined sound.

In another embodiment of the musical instrument simulator, the predetermined sound is a musical note.

In another embodiment of the musical instrument simulator, the musical instrument simulator causes the portable computing device to generate the musical note as the target sound.

In another embodiment of the musical instrument simulator, the at least one key modifier is a semitone modifier, and in response to a user manipulation of the semitone modifier, the musical instrument simulator causes the portable computing device to shift the musical note by one semitone to generate the target sound.

In another embodiment of the musical instrument simulator, the at least one key modifier includes an octave modifier, and in response to a user manipulation of the octave modifier, the musical instrument simulator causes the portable computing device to shift the musical note by one octave to generate the target sound.

In another embodiment of the musical instrument simulator, the target sound is a musical chord based on the musical note.

In another embodiment of the musical instrument simulator, the at least one key modifier is a semitone modifier, and in response to a user manipulation of the semitone modifier, the musical instrument simulator causes the portable computing device to shift the musical note by one semitone and generates a chord based on the shifted musical note as the target sound.

In another embodiment of the musical instrument simulator, the at least one key modifier is a chord modifier, and in response to a user manipulation of the chord modifier, the musical instrument simulator causes the portable computing device to generate a modified chord based on the musical note.

In another embodiment of the musical instrument simulator, the modified chord is a chord selected from the group consisting of: major, minor, augmented, diminished, half-diminished, dominant, second, third, fourth, fifth, sixth, seventh, ninth, eleventh, thirteenth, inversion, poly, and a combination of two or more such chords.

In another embodiment of the musical instrument simulator, the plurality of keys and the at least one key modifier are arranged on the first interface in accordance with a zone map, the zone map dividing the first interface into a plurality of zones each corresponding to a key or key modifier.

In another embodiment of the musical instrument simulator, each zone is larger in area than an area of the key or key modifier corresponding thereto.

In another embodiment of the musical instrument simulator, a user manipulation of the first interface occurring anywhere within one zone is processed as a user manipulation of the key or key modifier corresponding to the zone.

In another embodiment of the musical instrument simulator, a plurality of zone maps are stored in the portable computing device, and the musical instrument simulator is further configured to cause the portable computing device to retrieve one or more zone maps to display the first interface.

In another embodiment of the musical instrument simulator, the portable computing device comprises an accelerometer operable to detect a movement thereof, and the musical instrument simulator is configured to cause the portable computing device to modify the target sound in accordance with a detected movement.

In another embodiment of the musical instrument simulator, the musical instrument simulator causes the portable computing device to modify the target sound in a first manner upon detection of a movement of the portable computing device along a first axis, and causes the portable computing device to modify the target sound in a second manner upon detection of a movement of the portable computing device along a second axis.

In another embodiment of the musical instrument simulator, the musical instrument simulator causes the portable computing device to modify the target sound with a vibrato effect upon detection of a movement of the portable computing device.

In another embodiment of the musical instrument simulator, the portable computing device is a smartphone having a touchscreen display and an audio output, and the musical instrument simulator is a software application executable on the smartphone to cause the first interface to be displayed on the touchscreen and to cause the target sound to be generated through the audio output.

In another aspect of the present invention, an electronic musical instrument comprises a touchscreen interface displaying a plurality of keys and at least one key modifier; a processor for determining a target sound to be produced in response to a manipulation of one or more of the plurality of keys and the at least one key modifier; and an audio output for generating the target sound.

These and other aspects and embodiments are described in greater in the following description.

### BRIEF DESCRIPTION OF THE DRAWINGS

In order that the present invention can be more readily understood reference will now be made to the accompanying drawings which illustrate a preferred embodiment of the invention and wherein:

FIG. 1 illustrates an electronic musical instrument according to a first aspect of the present invention;

FIG. 2 illustrates an operation of the electronic musical instrument;

FIG. 3 illustrates a musical instrument simulator according to a second aspect of the present invention;

FIG. 4 illustrates a portable computing device according to a third aspect of the present invention;

FIG. 5 illustrates a zone map for an instrument interface generated by the musical instrument simulator;

FIG. 6 illustrates an exemplary alternative zone map configured for a tablet;

FIG. 7 illustrates an exemplary alternative zone map configured to simulate a saxophone;

FIG. 8 illustrates an exemplary alternative instrument interface;

FIG. 9 illustrates an operation of an electronic musical instrument employing the alternative instrument interface;

FIG. 10 illustrates a portable computing device according to a further embodiment;

FIG. 11 illustrates a use of an electronic musical instrument embodied by the portable computing device of the further embodiment;

FIG. 12 illustrates a one handed use of the electronic musical instrument according to the present invention; and

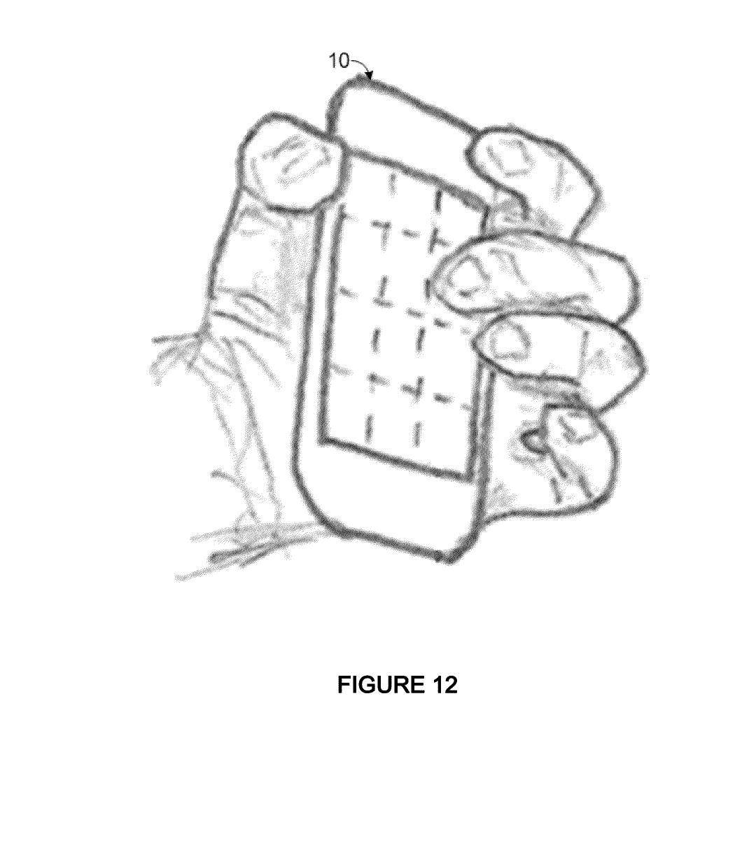

FIG. 13 illustrates a two handed use of the electronic musical instrument according to the present invention.

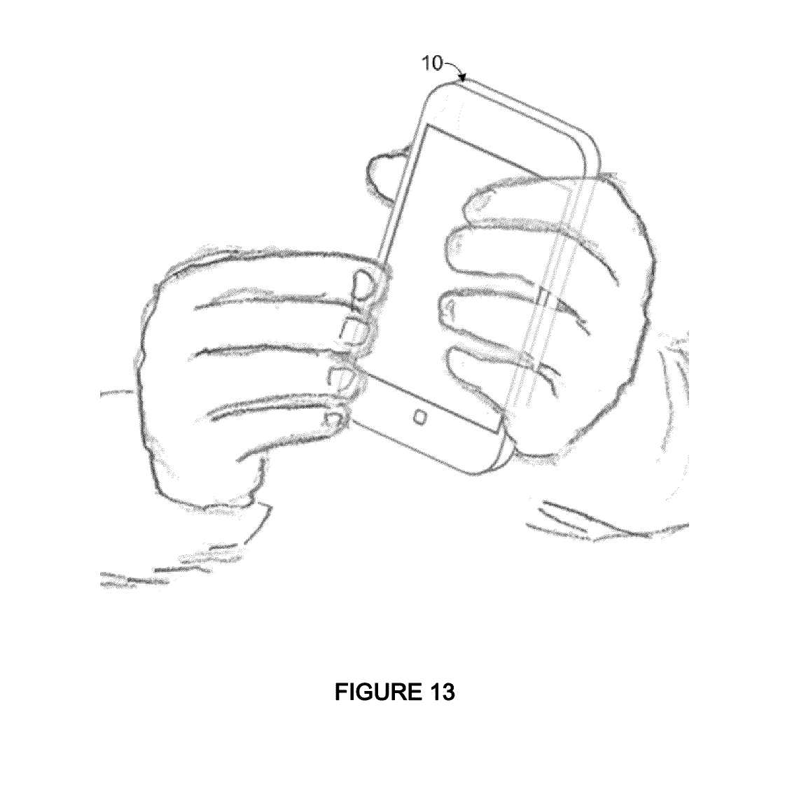

### DEFINITIONS

As used herein, and unless explicitly or implicitly otherwise stated or suggested, the term “key” is to be understood as referring to a virtual or physical mechanism, the manipulation of which produces a musical note or sound, or contributes to the production of a musical note or sound.

### DETAILED DESCRIPTION OF THE PREFERRED EMBODIMENT

In the following description, it is to be understood that like or the same reference numerals in different embodiments denote the same or similar features.

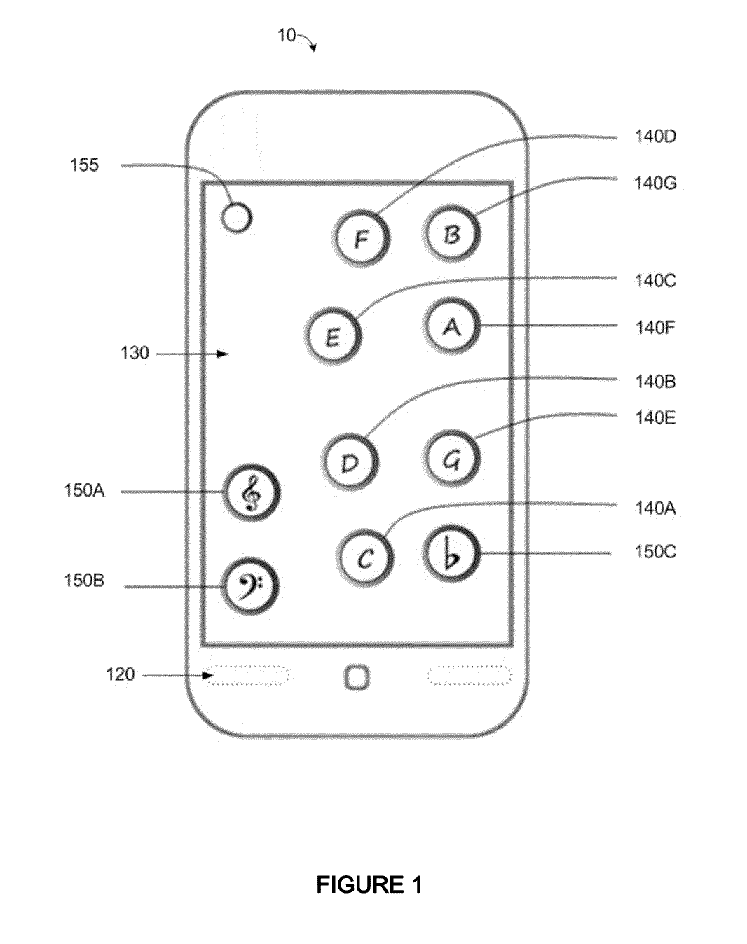

With reference to FIG. 1, an electronic musical instrument 10 according to a first aspect of the present invention is described. The electronic musical instrument 10 is playable by a user to produce a range of musical notes or sounds, for example in the form of a song.

The electronic musical instrument 10 includes an instrument interface 130, and an audio output 120. The instrument interface 130 defines a plurality of keys 140A to 140G (hereinafter generally referred to as keys or key 140), and one or more key modifiers 150A, 150B, 150C (hereinafter generally referred to as key modifiers or modifier 150). The instrument interface 130 may also define a menu button 155 for accessing non-musical functions of the electronic musical instrument 10, such as instrument settings and preferences.

Each key 140 is manipulable to produce a musical note or sound, or contribute to the production of a musical note or sound, from the audio output 120. The one or more key modifiers 150 are manipulable to modify a musical note or sound produced by the one or more keys 140, and may be, for example, an octave raiser 150A, an octave reducer 160B, and/or a semitone modifier 150C.

Embodiments of the electronic musical instrument 10 may be provided with varying numbers of keys 140 and key modifiers 150 for producing varying musical notes or sounds, and be arranged in varying positions on the instrument interface 130.

In a first preferred embodiment of the electronic musical instrument 10, however, the instrument interface 130 defines seven keys 140. The seven keys 140 are configured to respectively generate notes from the C Major scale, namely C-D-E-F-G-A-B. The seven keys 140 of the first embodiment provide the electronic musical instrument 10 with a basic musical range of seven notes.

The instrument interface 130 in the first preferred embodiment further includes the semitone modifier 150C. The semitone modifier 150C in the first embodiment is configured as a semitone reducer. The semitone modifier 150C, configured as a semitone reducer, is manipulable by the user to reduce a semitone of a note produced by one or more of the keys 140. The combination of the semitone modifier 150C and the seven keys 140 in the first embodiment provides the electronic musical instrument 10 with an expanded musical range of twelve notes.

Still further, the instrument interface 130 in the electronic musical instrument 10 of the first embodiment defines both an octave raiser 150A and an octave reducer 150C. The octave raiser 150A and octave reducer 1508 respectively raise and lower a music note produced by the keys 140 by one musical octave. The octave raiser 150A and octave reducer 1508 together with the seven keys 140 and semitone modifier 150C provide the electronic musical instrument 10 with an extended musical range of thirty six notes.

In the electronic musical instrument 10 of the first embodiment, the provision of the semitone modifier 150C, octave raiser 150A, and octave reducer 1508 increases the number of manipulable constructs on the instrument interface 130 from seven to ten. The addition of these three additional items, however, disproportionately increases the musical range of the electronic musical instrument 10 from a basic seven notes to an extended thirty six notes. The electronic musical instrument 10 of the first embodiment hence extends a playable range of notes, allowing for the playing of at least moderately complex songs, without a significant increase in the density of constructs displayed on the instrument interface 130.

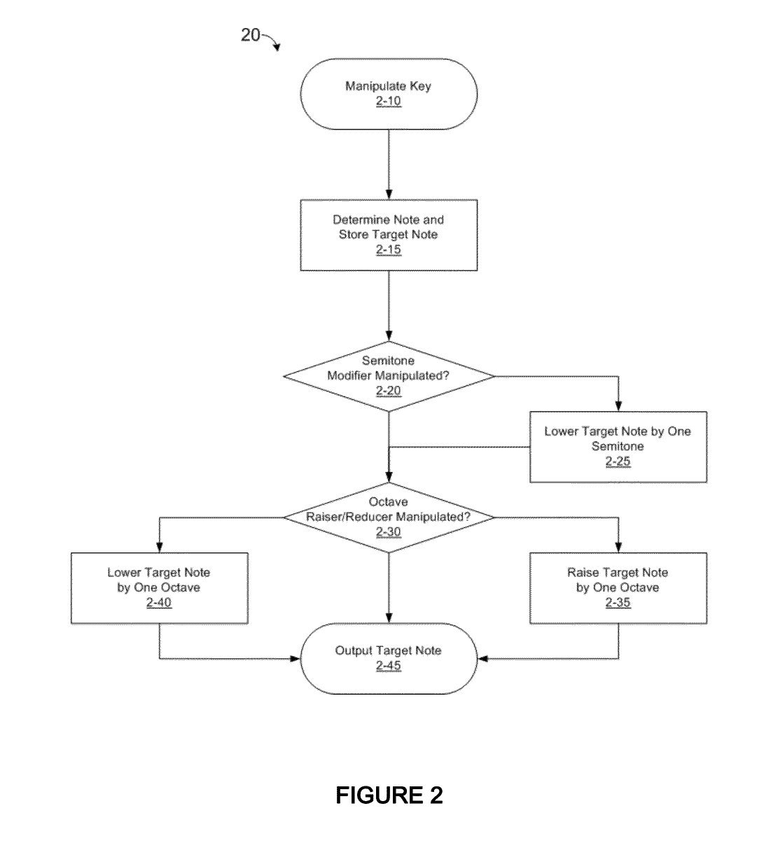

With reference to FIG. 2, an operation 20 of the electronic musical instrument 10 of the first preferred embodiment is described.

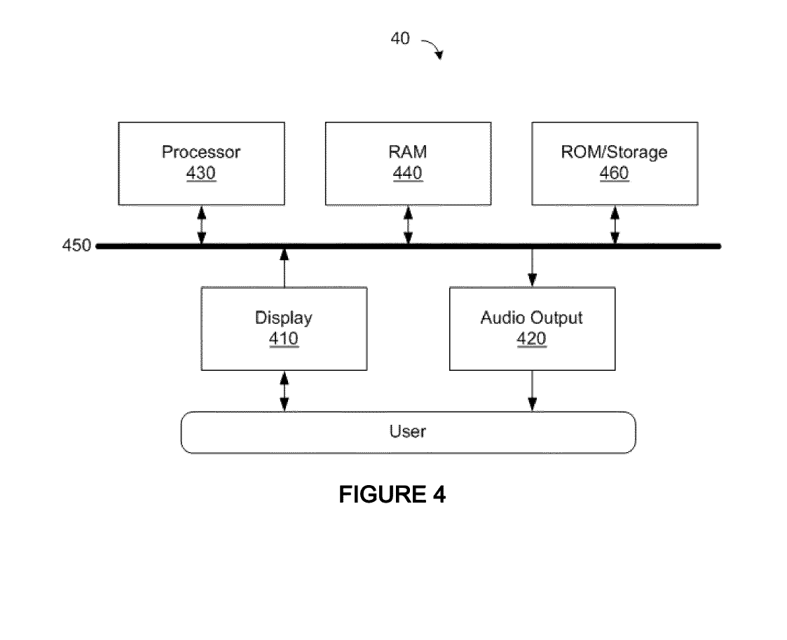

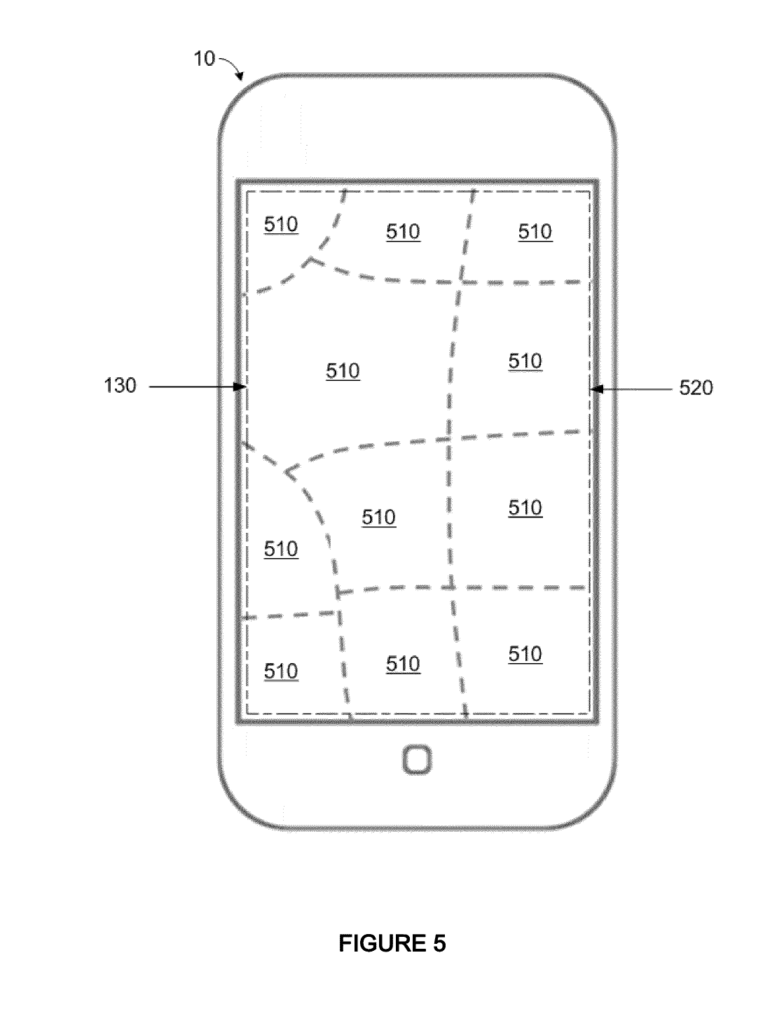

The electronic musical instrument 10, in use, is held in the hands of the user. The electronic musical instrument 10 may be held in one hand (as illustrated in FIG. 4) or in both hands (as illustrated in FIG. 5) in accordance with a preference of the user and an arrangement of the keys 140 on the instrument interface 130.

Returning to FIG. 2, at 2-10 the user operates (or plays) the electronic musical instrument 10 by manipulating a key 140 to produce a desired note.

At 2-15, in response to a detection of a key 140 being manipulated, the electronic musical instrument 10 determines which musical note corresponds to the manipulated key 140 and stores this note as a target note.

At 2-20, the electronic musical instrument 10 determines if the semitone modifier 150C is being manipulated by the user. If it is determined that the semitone modifier 150C is being manipulated by the user, the operation 20 proceeds to 2-25. Conversely, if it is determined that the semitone modifier 150C is not being manipulated by the user, the operation 20 proceeds to 2-30.

At 2-25, the target note is reduced in pitch by one semitone, and the operation 20 proceeds to 2-30.

At 2-30, the electronic musical instrument 10 determines if either the octave raiser 150A or the octave reducer 1508 is being manipulated by the user. If the octave raiser 150A is being manipulated, the operation 20 proceeds to 2-35. Alternatively, if the octave reducer 150B is being manipulated, the operation 20 proceeds to 2-40. If neither the octave raiser 150A nor the octave reducer 150B is being manipulated, the operation 20 proceeds to 2-45.

At 2-35, the target note is raised in pitch by one musical octave, and the operation 20 proceeds to 2-45.

At 2-40, the target note is lowered in pitch by one musical octave, and the operation 20 proceeds to 2-45.

At 2-45, the target note is generated and outputted through the audio output 120.

The operation 20 is performed for each detected manipulation of a key 140, such that a series of manipulations of the keys 140 and key modifiers 150 produces a series of musical notes or sound to form, for example, a song.

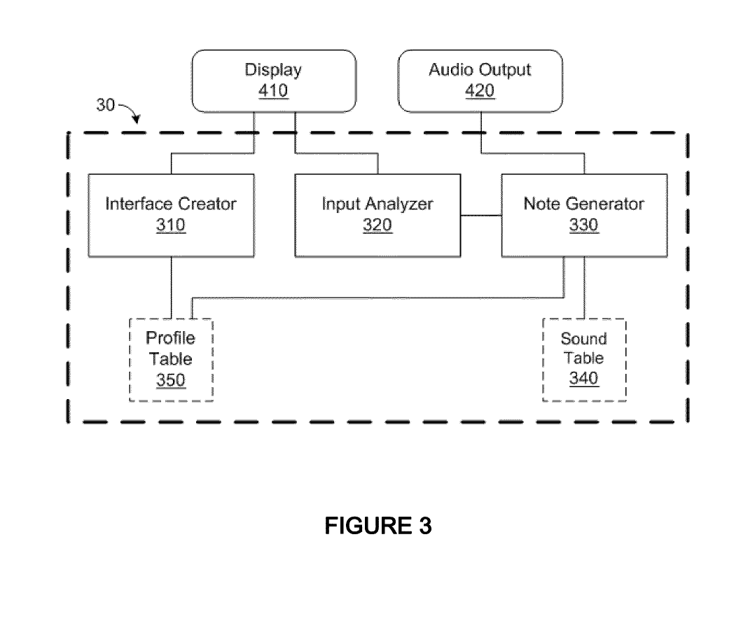

The electronic musical instrument 10 and its operation 20 are realized in the form of code executed on a portable computing device. The code represents a musical instrument simulator according to a second aspect of the present invention. FIG. 3 logically illustrates the musical instrument simulator 30 according to the second aspect of the present invention, and with reference to which the musical instrument simulator 30 is described.

The musical instrument simulator 30 instructs and controls logical units within the portable computing device to bring into effect elements of the electronic musical instrument 10, for example the instrument interface 130, keys 140, key modifiers 150, and generation of notes through the audio output 120. The musical instrument simulator 30 includes an interface creator 310, input analyzer 320, and a note generator 330. The musical instrument simulator 30 may also include a sound table 340 and a profile table 350.

The interface creator 310 is a collection of code configured to instruct and control the logical units of the portable computing device so as to generate the instrument interface 130 on a display 410 of the portable computing device 40. The interface creator 310 determines, for example, where and how many keys 140 and key modifiers 150 are to be displayed on the instrument interface 130. The interface creator 310 is further configured to allow variations of the instrument interface 130, including for example, a colour, brightness, theme, mapping, zoning, and the like.

Predetermined interface settings for how the interface creator 310 generates the instrument interface 130 may be stored in the profile table 350. The profile table 350 stores, for example, a default interface setting, one or more user customized interface settings, interface settings simulating one or more instruments, and the like.

The input analyzer 320 is a collection of code configured to receive input from the display of the portable computing device 40. The input is indicative of, for example, manipulations of the keys 140 and/or key modifiers 150 performed by the user through the instrument interface 130. The input analyzer 320 analyzes the received input to determine which keys 140 and/or key modifiers 150 are being manipulated by the user. This determination of which keys 140 and/or modifiers 150 are being manipulated by the user are passed to the note generator 330.

The note generator 330 is a collection of code configured to determine which sounds or musical notes are to be generated in response to the keys 140 and key modifiers 150 being manipulated by the user. The note generator 330 receives from the input analyzer 320 the determination of which keys 140 are being manipulated by the user and maps each key 140 to a sound or musical note in accordance with a predetermined mapping. Similarly, the note generator 330 receives from the input analyzer 320 the determination of which key modifiers 150 are being manipulated by the user and maps each key modifier 150 to a modification function in accordance with a predetermined mapping.

From the predetermined sound/note and modification function mappings, the note generator 330 determines a target sound to be produced by an audio output of the portable computing device. The note generator 330 is further configured to instruct and configure the logical units of the portable computing device to cause the audio output of the portable computing device to produce the target sound.

The predetermined mapping of a key 140 to a sound or musical note, and the predetermined mapping of a key modifier 150 to a modification function may form part of a predetermined sound set stored in the sound table 340. Each sound set records a mapping for each key 140 defined on the instrument interface 130 to a specific sound or musical note, and records a mapping for each key modifier 150 defined on the instrument interface 130 to a specific modification function.

One or more predetermined sound sets may be stored in the sound table 340 and activated for use by the electronic musical instrument 10, for example by manipulation of the menu button 155. Different sound sets made be activated to simulate sounds from various instruments or custom sound sets. For example, the sound table 340 may store a sound set for simulating the notes of a violin, a sound set for simulating the notes of a trumpet, a sound set to simulate various sounds produced by a drum set, and a sound set for simulating various animal noises. The sound table 340 may be updated to add, remove, and modify the sound sets stored therein.

The musical instrument simulator 30 in a preferred embodiment is an application running on the portable computing device. In a typical execution of the musical instrument simulator 30, the interface creator 310 firstly retrieves a profile from the profile table 350. In accordance with the retrieved profile, the interface creator 310 generates an instrument interface 130 on a display of the portable computing device. Specifically, the interface creator 310 generates an instrument interface 130 having a number of keys and key modifiers 150, arranged, sized, mapped, and zoned in accordance with the retrieved profile.

The user's manipulations of the keys 140 and key modifiers 150 on the instrument interface 130 are detected and analyzed by the input analyzer 320. The input analyzer 320 determines which keys 140 and key modifiers 150 have been manipulated by the user, and informs the note generator 330 of this determination.

Based on the determination provided thereto by the input analyzer 320, the note generator 330 refers to the sound table 340 to determine which musical notes or sounds are to be generated. The determined musical notes or sounds are caused to be generated by the note generator 330 through an audio output of the portable computing device, thereby effecting the playing of the intended notes indicated by the user's manipulation of the keys 140 and key modifiers 150.

Referring to FIG. 4, a portable computing device 40 according to a third aspect of the present invention is schematically illustrated. In a preferred form, the portable computing device 40 is a smartphone or tablet. The portable computing device 40 is operable to execute code representing the musical instrument simulator 30 so as to realize the electronic musical instrument 10.

The portable computing device 40 comprises a display 410, an audio output 420, a processor 430, and a working memory 440. The portable computing device 40 may also comprise a storage memory 460. Each of the elements of the portable computing device 40 are interconnected either directly or indirectly by a bus 450.

The display 410 is operable to display the instrument interface 130 to the user. In a preferred form, the display 410 is a touchscreen display capable of receiving input from the user, such as the user's manipulation of the keys 140 and key modifiers 150. The display 410 is, however, not limited to being a touchscreen display, and may take other forms such as a projection display capable of sensing movement within the projected display.

The audio output 420 is operable to generate the target sounds determined by the note generator 330. The audio output 420 may be, for example, a physical device such as a speaker, headphone, and/or mechanical diaphragm, or a wired or wireless port or connection to one or more such physical devices. In a preferred form, the portable computing device 40 includes one or more of a speaker, a headphone jack, and a Bluetooth™ communications interface serving as the audio output 420. The audio output 420 realizes the audio output 120 of the electronic musical instrument 10.

The processor 430, together with the working memory 440, is operable to effect the execution of the code representing the musical instrument simulator 30. Through the execution of the code, the processor 430 performs the functions and processes of the interface creator 310, input analyzer 320, and note generator 340, and further effects the operation 20 of the electronic musical instrument 10. The working memory 440 is used by the processor 430 to facilitate execution of the code.

The storage memory 460 may be used to store the musical instrument simulator 30, including the code, the profile table, and the sound table. The storage memory 460 may be a read-only memory such as an EPROM or EEPROM, a read-write memory such as a magnetic or solid-state storage device, and/or a combination of such memories. In one embodiment, the storage memory 460 is also used to record the musical note or sounds produced by the electronic musical instrument 10 by the user.

In a typical operation of the portable computing device 40, the code representing the musical instrument simulator 30 is retrieved from the storage memory 460 by the processor 430 to commence execution of the musical instrument simulator 30. The processor 430 executes the musical instrument simulator 30 so as to realize the interface creator 310, input analyzer 320, and note generator 340. The processor 430, through the execution of the musical instrument simulator 30, generates on the display 410 the instrument interface 130 thereby presenting to the user the keys 140 and key modifiers 150.

The display 410 receives input from the user in the form of manipulations of the keys 140 and key modifiers 150. The inputs are processed by the processor 430 embodying the input analyzer 320 and note generator 330, whereby musical notes or sounds are generated through the audio output 420. Accordingly, the portable computing device 40 realizes the electronic musical instrument 10 through the execution of the code representing the musical instrument simulator 30.

The electronic musical instrument 10, musical instrument simulator 30, and portable computing device 40 described above are to be understood as exemplary, and of a first preferred embodiment. Individual elements of the present invention, as well as variations and alternative embodiments will now be described in greater detail.

Referring to FIG. 5, the instrument interface 130 generated by the interface creator 310 is described in greater detail.

The instrument interface 130 is delineated into a plurality of zones 510 making up a zone map 520. Each zone 510 corresponds to a respective key 140 or key modifier 150 on the instrument interface 130. The zones 510 are each sized to be at least the size of the key 140 or key modifier 150 they correspond to, and are preferably larger. Individual zones 510 may be sized differently to other zones.

Each zone 510 represents the area within which the detection of a user manipulation will be deemed as a manipulation of the key 140 or key modifier 150 corresponding to the zone 510. In a preferred embodiment, keys 140 and key modifiers 150 that require a larger user movement (e.g. greater travel distance) to manipulate are provided with a larger zone 510, whilst keys 140 and key modifiers 150 requiring little movement, such as keys 140 that are at a ‘rest’ position for a user, are provided with a smaller zone 510.

The delineation of the instrument interface 130 into the plurality of zones 510 allows the instrument interface 130 to accommodate inaccuracies in the manipulation of the keys 140 and key modifiers 150 by the user. In the preferred embodiment where keys 140 and key modifiers 150 that require a larger user movement to manipulated are allocated a larger zone 510, a greater tolerance for inaccurate finger positioning is provided. Accordingly, a user intended musical note or sound is more likely to be produced even if a user's finger is misplaced. The provision of the zones 510 further simulates to a degree the physical tactile cues that a user would have when playing a mechanically operated musical instrument.

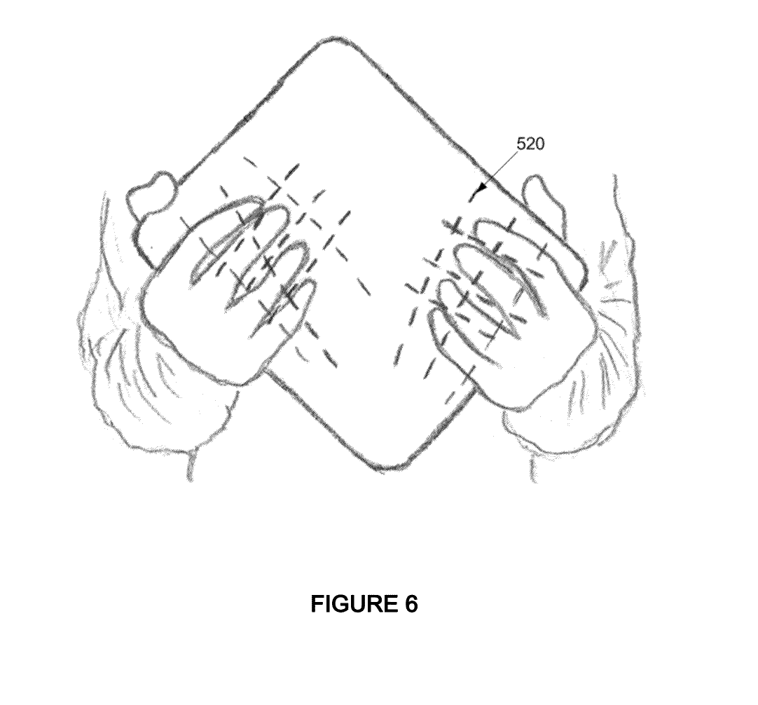

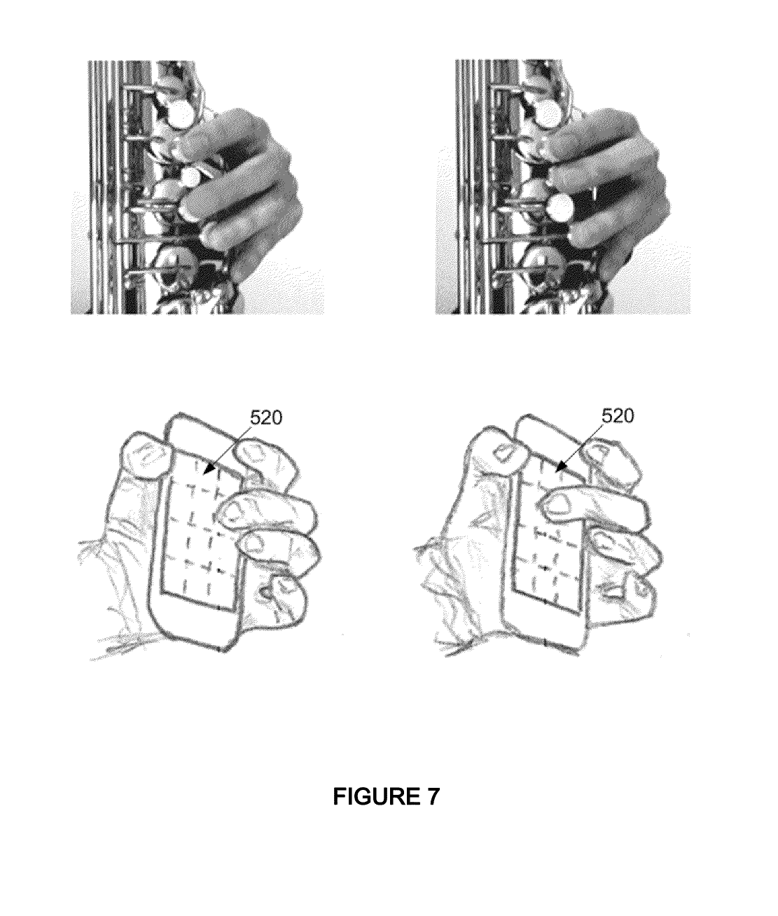

A plurality of zone maps 520 may be stored in the profile table 350. Specific zone maps may be configured and saved in the profile table 350 to, for example, simulate different musical instruments, satisfy user preferences, accommodate various user physical limitations (e.g. hand size, finger lengths, medical conditions, etc.), and the like. FIG. 6 illustrates an exemplary zone map 620 for an electronic musical instrument embodied on a tablet and played with the tablet held in a diagonal orientation. FIG. 7 illustrates a zone map 720 for a saxophone-like instrument embodied on a smartphone.

The zone maps 520 stored in the profile table 350 may be updated, edited, created, and removed by the user through the menu button 155 on the instrument interface 130.

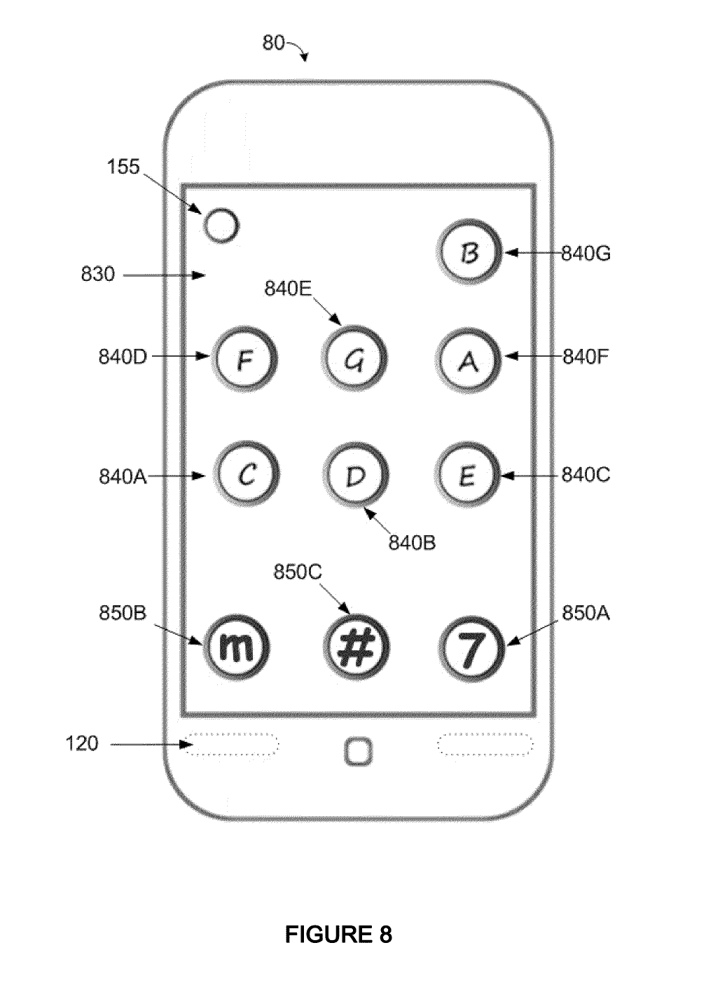

Referring to FIG. 8, an exemplary alternative instrument interface 830 is described. The alternative instrument interface 830 is created by the interface creator 310 using a zone map and predetermined interface setting obtained from the profile table 350 for realizing a chord-based electronic musical instrument 80.

The alternative instrument interface 830 defines seven keys 840 and three key modifiers 850. The seven keys defined in the alternative instrument interface 840 are C-D-E-F-G-A-B. The keys 140 in the alternative instrument interface 830 are arranged to facilitate the playing of chord music, and in contrast to the electronic musical instrument 10 of the first embodiment, each key 840 plays a predetermined chord rather than a single musical note.

The key modifiers 850 of the alternative instrument interface 830 includes a semitone modifier 850C, a minor-chord modifier 850B, and a seventh-chord modifier 850A. The semitone modifier 850C in the alternative instrument interface 830 is a semitone raiser which raises a semitone of a note played by a key 140. The minor-chord modifier 850B and seventh-chord modifier 850A respectively modify a chord to be played by shifting it into a minor or seventh chord.

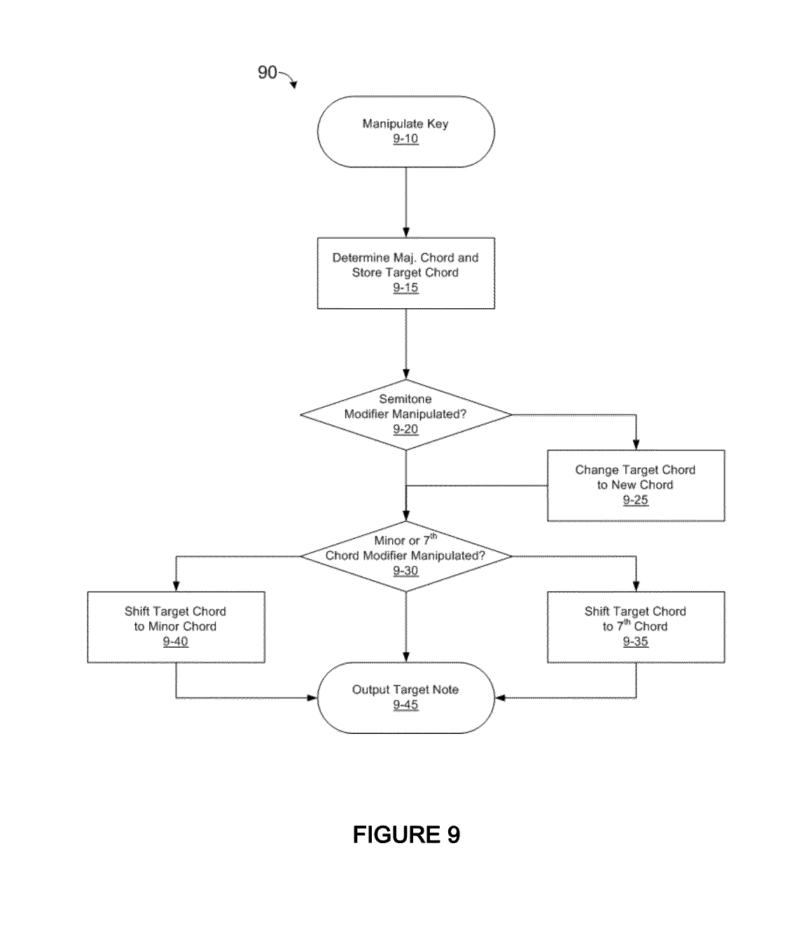

Referring to FIG. 9, an operation 90 of the electronic musical instrument 80 using the alternative instrument interface 830 is described.

Commencing at 9-10, the user operates (or plays) the electronic musical instrument 80 by manipulating a key 840 to produce a desired chord.

At 9-15, in response to a detection of a key 840 being manipulated, the electronic musical instrument 80 determines which major musical chord corresponds to the manipulated key 840 and stores this chord as a target chord.

At 9-20, the electronic musical instrument 80 determines if the semitone modifier 850C is being manipulated by the user. If it is determined that the semitone modifier 850C is being manipulated by the user, the operation 90 proceeds to 9-25. Conversely, if it is determined that the semitone modifier 850C is not being manipulated by the user, the operation 80 proceeds to 9-30.

At 9-25, the target chord is amended to a chord corresponding to a note that is one semitone higher in pitch than the key 840 being manipulated. For example, if the key 840 being manipulated is a C, the target chord is amended from being a C-Major chord to a C#-major chord. The operation 80 then proceeds to 9-30.

At 9-30, the electronic musical instrument 10 determines if either the seventh-chord modifier 850A or the minor-chord modifier 850B is being manipulated by the user. If the seventh-chord modifier 850A is being manipulated, the operation 80 proceeds to 9-35. Alternatively, if the seventh-chord modifier 850B is being manipulated, the operation 80 proceeds to 9-40. If neither the seventh-chord modifier 850A nor the minor-chord modifier 850B is being manipulated, the operation 80 proceeds to 9-45.

At 9-35, the target chord is shifted to a seventh-chord, and the operation 80 proceeds to 9-45.

At 9-40, the target chord is shifted to a minor-chord, and the operation proceeds to 9-45.

At 9-45, the target chord is generated and outputted through the audio output 120.

The operation 90 is performed for each detected manipulation of a key 840, such that a series of manipulations of the keys 840 and key modifiers 850 produces a series of musical chords to form, for example, a song.

The alternative instrument interface 830 and its operation 90 represents a further variation of the instrument interface 130 which similarly expands a range of musical notes or sounds producible by the electronic musical instrument 10 without significant increasing the density of manipulable constructs on the instrument interface 130. Other variations will be apparent to the skilled reader and are encompassed within the scope of the present invention.

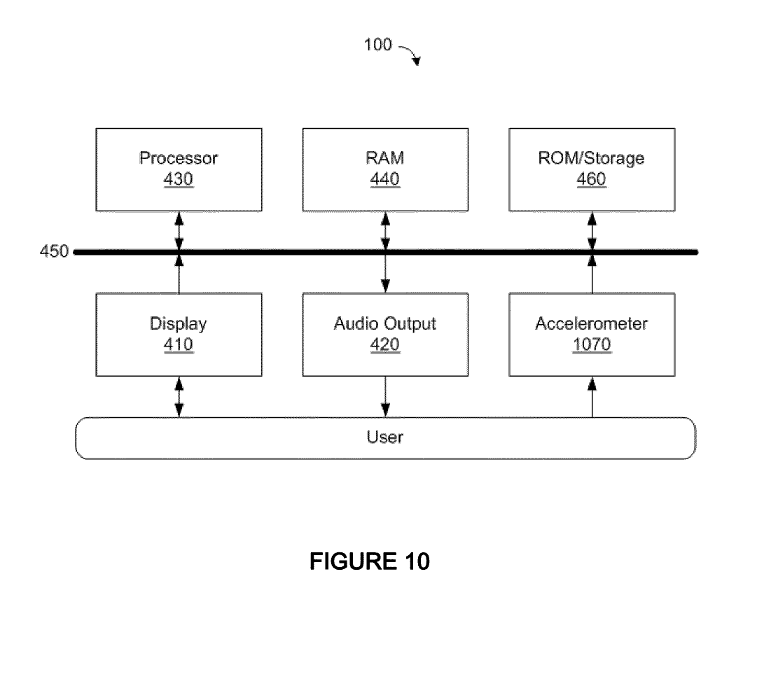

Referring to FIG. 10, a portable computing device 100 of a further embodiment of the present invention is described. The portable computing device 100 incorporates an accelerometer 1070 therein, but is otherwise configured as per the portable computing device 40 illustrated in FIG. 4.

The portable computing device 100 is operable to execute code representing a modified musical instrument simulator. The modified musical instrument simulator is similar to the musical instrument simulator 30 illustrated in FIG. 3 but where the input analyzer 320 is further configured to receive input from the accelerometer 1070, and the note generator is further configured to modify a target musical note, chord, or sound in accordance with the input received from the accelerometer 1070.

An electronic musical instrument realized by the execution of the modified musical instrument simulator on the portable computing device 100 is operable to, for example, generate a vibrato on effect in response to a magnitude and frequency of an acceleration applied thereto and detected by the accelerometer.

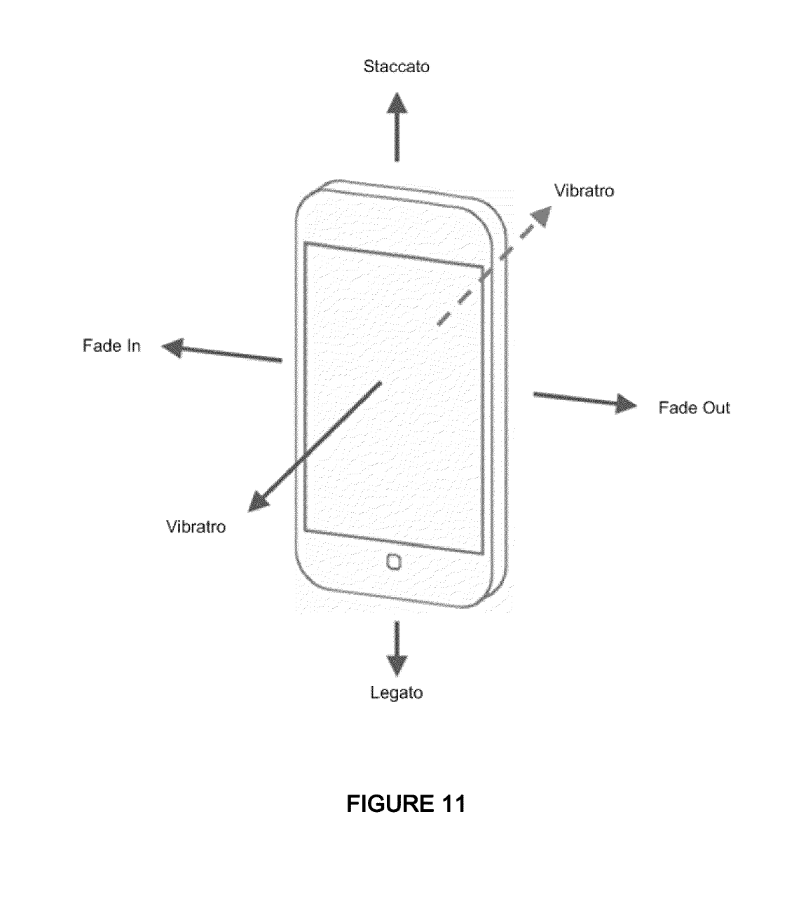

In a preferred form, the accelerometer 1070 is sensitive along three axes as illustrated in FIG. 11, and the modified musical instrument simulator is configured to modify the target musical note, chord or sound in different manners, depending on the axis of acceleration detected. For example, an acceleration detected along the first axis may generate a vibrato effect, an acceleration detected along the second axis may generate a fade in or fade out effect, whilst an acceleration detected along the third axis may generate a staccato or legato effect.

The electronic musical instrument, musical instrument simulator, and portable computing device according to the present invention are also preferably adapted to allow for recording of notes and sounds produced thereby. The notes and sounds produced may be stored, for example, in the storage memory 460 of the portable computing device. The recording of the musical notes, chords or sounds played by a user allows music or other compilations produced by the user to be saved, edited, and shared. Collaboration between multiple users is facilitated, allowing for bands and orchestras to be formed remotely.

The electronic musical instrument 10, 80, the instrument interface 130, 830 and the portable computing devices 40, 100 described herein are to be understood as exemplary. The present invention is not limited to only the embodiments disclosed. Other electronic musical instruments having different instrument interfaces, each utilizing one or more key modifiers to expand and extend a range of musical notes and sounds producible thereby without significantly increasing the density of the instrument interface, are within the scope of the present invention.

The keys 140, 840 and key modifiers 150, 850 are also to be understood as exemplary. More than or less than seven keys 140, 840 may be defined on an instrument interface 130, 830, and may be defined in any range and arrangement of positions. The keys 140, 840 are not limited to being from the C Major scale, and may indeed be from any scale, or taken from a combination of two or more scales, or be pre-recorded sounds.

The key modifiers 150, 850 are not limited to being semitone raisers, semitone reducers, octave raisers, octave reducers, minor-chord shifters, and seventh-chord shifters. The key modifiers 150, 850 may alternatively or additionally be, for example, a diminished-seventh chord shifter, an augmented-seventh chord shifter, a note-to-chord modifier, a capo, and the like.

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

The claims defining the invention are as follows:

1. A musical instrument simulator executable on a portable computing device, the simulator configured to cause the portable computing device to:
display a first interface defining a plurality of keys and at least one key modifier; and
generate a target sound in response to a user manipulation of one or more of the plurality of keys and the at least one key modifier.

2. A musical instrument simulator as claimed in claim 1, wherein each of the plurality of keys is mapped to a predetermined sound, and the musical instrument simulator causes the portable computing device to generate the target sound from the predetermined sound.

3. A musical instrument simulator as claimed in claim 2, wherein the predetermined sound is a musical note.

4. A musical instrument simulator as claimed in claim 3, wherein the musical instrument simulator causes the portable computing device to generate the musical note as the target sound.

5. A musical instrument simulator as claimed in claim 3, wherein the at least one key modifier is a semitone modifier, and in response to a user manipulation of the semitone modifier, the musical instrument simulator causes the portable computing device to shift the musical note by one semitone to generate the target sound.

6. A musical instrument simulator as claimed in claim 3, wherein the at least one key modifier includes an octave modifier, and in response to a user manipulation of the octave modifier, the musical instrument simulator causes the portable computing device to shift the musical note by one octave to generate the target sound.

7. A musical instrument simulator as claimed in claim 3, wherein the target sound is a musical chord based on the musical note.

8. A musical instrument simulator as claimed in claim 7, wherein the at least one key modifier is a semitone modifier, and in response to a user manipulation of the semitone modifier, the musical instrument simulator causes the portable computing device to shift the musical note by one semitone and generates a chord based on the shifted musical note as the target sound.

9. A musical instrument simulator as claimed in claim 7, wherein the at least one key modifier is a chord modifier, and in response to a user manipulation of the chord modifier, the musical instrument simulator causes the portable computing device to generate a modified chord based on the musical note.

10. A musical instrument simulator as claimed in claim 9, wherein the modified chord is a chord selected from the group consisting of: major, minor, augmented, diminished, half-diminished, dominant, second, third, fourth, fifth, sixth, seventh, ninth, eleventh, thirteenth, inversion, poly, and a combination of two or more such chords.

11. A musical instrument simulator as claimed in claim 1, wherein the plurality of keys and the at least one key modifier are arranged on the first interface in accordance with a zone map, the zone map dividing the first interface into a plurality of zones each corresponding to a key or key modifier.

12. A musical instrument simulator as claimed in claim 11, wherein each zone is larger in area than an area of the key or key modifier corresponding thereto.

13. A musical instrument simulator as claimed in claim 12, wherein a user manipulation of the first interface occurring anywhere within one zone is processed as a user manipulation of the key or key modifier corresponding to the zone.

14. A musical instrument simulator as claimed in claim 11, wherein a plurality of zone maps are stored in the portable computing device, and the musical instrument simulator is further configured to cause the portable computing device to retrieve one or more zone maps to display the first interface.

15. A musical instrument simulator as claimed in claim 1, wherein the portable computing device comprises an accelerometer operable to detect a movement thereof, and the musical instrument simulator is configured to cause the portable computing device to modify the target sound in accordance with a detected movement.

16. A musical instrument simulator as claimed in claim 15, wherein the musical instrument simulator causes the portable computing device to modify the target sound in a first manner upon detection of a movement of the portable computing device along a first axis, and causes the portable computing device to modify the target sound in a second manner upon detection of a movement of the portable computing device along a second axis.

17. A musical instrument simulator as claimed in claim 15, wherein the musical instrument simulator causes the portable computing device to modify the target sound with a vibrato effect upon detection of a movement of the portable computing device.

18. A musical instrument simulator as claimed in claim 1, wherein the portable computing device is a smartphone having a touchscreen display and an audio output, and the musical instrument simulator is a software application executable on the smartphone to cause the first interface to be displayed on the touchscreen and to cause the target sound to be generated through the audio output.

19. An electronic musical instrument comprising:
a touchscreen interface displaying a plurality of keys and at least one key modifier;
a processor for determining a target sound to be produced in response to a manipulation of one or more of the plurality of keys and the at least one key modifier; and
an audio output for generating the target sound.
